(19) United States
(12) Patent Application Publication
(10) Pub. No.: US 2005/0049931 A1
(43) Pub. Date: Mar. 3, 2005

(54) Digital content kiosk and associated methods for delivering selected digital content to a user

(76) Inventors: Marc Brian Wisnudel, (US); Erik van de Grampel, (US); Randy Robertson, (US)

Correspondence Address: Christopher L. Bernard;Christopher L. Bernard, PLLC, 511 West 8th Street #2B, Charlotte, NC, 28202, US

(21) Appl. No.: 10/652,771

(22) Filed: Aug. 29, 2003

(51) Int. Cl. G06F 17/60

(52) U.S. Cl. 705/26

(57) ABSTRACT

The present invention provides a digital content kiosk system operable for delivering selected digital content to a user. The digital content kiosk system of the present invention includes a limited-play recordable data storage medium configured to receive selected digital content and a data storage media recording device operable for recording the selected digital content on the limited-play recordable data storage medium at the request of a user. The limited-play recordable data storage medium of the present invention includes a reflective layer, a recording layer disposed directly or indirectly adjacent to the reflective layer, and at least one of a reactive layer and a reactive bonding adhesive layer disposed between the data storage media recording device and at least one of the reflective layer and the recording layer.

### FIELD OF THE INVENTION

The present invention relates generally to systems and methods for the distribution of digital content. More specifically, the present invention relates to a digital content kiosk and associated limited-play recordable data storage media.

### BACKGROUND OF THE INVENTION

It is desirable for digital content owners, such as music companies, movie studios, video game manufacturers, computer software manufacturers and the like, to have increased flexibility in the distribution of their digital content. Digital content kiosks are becoming an increasingly popular means for displaying, and in some cases, distributing digital content, such as digital photographs, music, movie previews, movies, video games, computer software and the like. Conventional digital content kiosks utilize a variety of data storage media, such as digital photographs, video (VHS) tapes, computer diskettes and the like, compact discs (CDs), digital versatile discs (DVDs), multi-layered structures (such as DVD-5 and DVD-9), multi-sided structures (such as DVD-10 and DVD-18), magneto-optic discs (MOs) and the like. However, because these data storage media are pre-mastered, the choice of digital content available to a user is often limited. The costly manufacturing and replication process associated with the data storage media necessitates the production of hundreds to thousands of the data storage media in order to make the production process cost-effective. Thus, the production and distribution of individual or small lots of pre-mastered data storage media is cost-prohibitive.

One possible solution to this problem is the use of write-once or re-writable formats (such as CD-R, CD-RW, DVD-R, DVD-RW, DVD+RW, DVD-RAM, MO and the like). Such data storage media would allow for the “on-demand” distribution of digital content, expanding the choice of digital content available to a user and eliminating the need for the production of hundreds to thousands of pre-mastered data storage media. However, these data storage media provide little protection for a digital content owner's intellectual property.

In various applications, such as the present application, it is desirable to have a data storage medium with a limited life. There are several methods for manufacturing limited-play data storage media. One method includes forming a disc wherein the reflective layer is protected with a porous layer such that the reflective layer becomes oxidized over a predetermined period of time. Once the reflective layer attains a given level of oxidation, the disc is no longer readable by a data storage media device. Another method includes depositing a coating containing a reactive dye and, optionally, one or more other additives on the surface of the disc. Upon exposure to oxygen, the reactive dye, which is initially colorless, is oxidized to form an opaque or semi-opaque layer over a predetermined period of time, rendering the disc unreadable. Alternatively, a layer containing the reactive dye may be “sandwiched” between the other layers of the disc. Finally, the disc may incorporate one or more reactive bonding adhesive layers.

Thus, what is needed is an easy-to-use digital content kiosk that allows for the on-demand distribution of digital content and that provides adequate protection for a digital content owner's intellectual property. In other words, what is needed is a digital content kiosk that utilizes a limited-play recordable data storage medium that provides access to digital content, audio, video or data, during a limited period of time and is not easily defeated, providing adequate protection for a digital content owner's intellectual property or highly-sensitive information. This digital content kiosk would allow a user to select and purchase digital content, such as a digital photograph, music, a movie preview, a movie, a video game, computer software or the like, on demand, in a convenient location and for a relatively low price. Advantageously, the digital content kiosk and associated limited-play recordable data storage media of the present invention would make it economically attractive to manufacture and distribute limited quantities of digital content.

### BRIEF SUMMARY OF THE INVENTION

In various embodiments, the present invention provides an easy-to-use digital content kiosk that allows for the on-demand distribution of digital content and that provides adequate protection for a digital content owner's intellectual property. In other words, the present invention provides a digital content kiosk that utilizes a limited-play recordable data storage medium that provides access to digital content, audio, video or data, during a limited period of time and is not easily defeated, providing adequate protection for a digital content owner's intellectual property or highly-sensitive information. The limited-play recordable data storage medium incorporates one or more reactive layers and/or one or more reactive bonding adhesive layers that render the limited-play recordable data storage medium unreadable by a data storage media device after a predetermined period of time. This digital content kiosk allows a user to select and purchase digital content, such as a digital photograph, music, a movie preview, a movie, a video game, computer software or the like, on demand, in a convenient location and for a relatively low price. Advantageously, the digital content kiosk and associated limited-play recordable data storage media of the present invention make it economically attractive to manufacture and distribute limited quantities of digital content.

In one embodiment of the present invention, a digital content kiosk system operable for delivering selected digital content to a user includes a recordable data storage medium configured to receive selected digital content and a data storage media recording device operable for recording the selected digital content on the recordable data storage medium at the request of a user.

In another embodiment of the present invention, a digital content kiosk system operable for delivering selected digital content to a user includes a limited-play recordable data storage medium configured to receive selected digital content and a data storage media recording device operable for recording the selected digital content on the limited-play recordable data storage medium at the request of a user.

In a further embodiment of the present invention, a method for delivering selected digital content to a user includes providing a recordable data storage medium configured to receive selected digital content, providing a data storage media recording device operable for recording the selected digital content on the recordable data storage medium and recording the selected digital content on the recordable data storage medium at the request of a user.

In a still further embodiment of the present invention, a limited-play recordable data storage medium configured to receive selected digital content includes a reflective layer, a recording layer disposed directly or indirectly adjacent to the reflective layer, and at least one of a reactive layer and a reactive bonding adhesive layer disposed between a data storage media recording device and at least one of the reflective layer and the recording layer.

### BRIEF DESCRIPTION OF THE DRAWINGS

FIG. 1 is a schematic diagram illustrating one embodiment of the digital content kiosk of the present invention;

FIG. 2 is a schematic diagram illustrating one embodiment of the limited-play recordable data storage medium of the present invention;

FIG. 3 is a schematic diagram illustrating another embodiment of the limited-play recordable data storage medium of the present invention;

FIG. 4 is a schematic diagram illustrating a further embodiment of the limited-play recordable data storage medium of the present invention;

FIG. 5 is a schematic diagram illustrating a still further embodiment of the limited-play recordable data storage medium of the present invention; and

FIG. 6 is a schematic diagram illustrating a still further embodiment of the limited-play recordable data storage medium of the present invention.

### DETAILED DESCRIPTION OF THE INVENTION

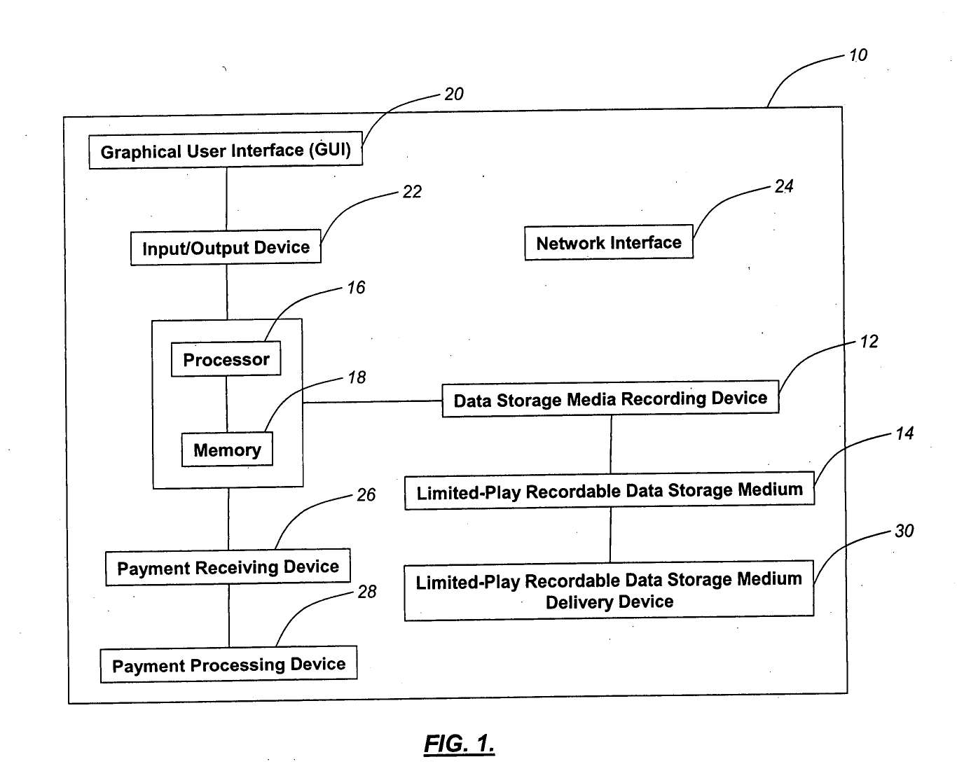

Referring to FIG. 1, in one embodiment, the digital content kiosk 10 of the present invention includes a data storage media recording device 12, such as a CD-R device, a CD-RW device, a DVD-R device, a DVD-RW device, a DVD+RW device, a DVD-RAM device, an MO device, another optical and/or magnetic data storage device or the like, well known to those of ordinary skill in the art. The data storage media recording device 12 may also include a non-volatile memory card device (such as a SecureDigital Card device, a MultiMedia Card device, a Memory Stick device, a SmartMedia Card device, a CompactFlash Card device, a USB Flash Card device or the like) or a removable magnetic hard drive (such as a microdrive, a pen drive, a cartridge device or the like). The data storage media recording device 12 is operable for recording digital content, such as a digital photograph, music, a movie preview, a movie, a video game, computer software or the like, on a recordable data storage medium 14, such as a CD-R, a CD-RW, a DVD-R, a DVD-RW, a DVD+RW, a DVD-RAM, an MO disc or the like, well known to those of ordinary skill in the art. Other suitable recordable data storage media 14 include, but are not limited to, non-volatile memory cards (such as SecureDigital Cards, MultiMedia Cards, Memory Sticks, SmartMedia Cards, CompactFlash Cards and USB Flash Cards) and removable magnetic hard drive cartridges.

Preferably, the recordable data storage medium 14 is a limited-play recordable data storage medium, as described in greater detail herein below. In one exemplary embodiment, the limited-play recordable data storage medium will expire if not stored in an inert (oxygen and/or water-free) environment. In an overlapping embodiment, the limited-play recordable data storage medium will expire after a predetermined amount of time as determined by a software algorithm and/or an encryption-based Digital Rights Management (DRM) mechanism. In another overlapping embodiment, the limited-play recordable data storage medium will expire after a predetermined amount of time as determined in combination by a software algorithm and/or an encryption-based DRM mechanism and exposure to an environmental trigger. The recordable data storage medium 14 may be selectively provided by a user or, alternatively, may be obtained from a supply of recordable data storage media 14 disposed within the digital content kiosk 10. In the later case, the recordable data storage medium 14 may be appropriately packaged and/or stored in an inert environment.

The operation of the data storage media recording device 12 is directed and controlled by a processor 16 coupled with a memory 18. The user selects digital content that he or she would like recorded on the recordable data storage medium 14 from a list of potential digital content via a graphical user interface (GUI) 20, such as a video display or the like, and an input/output device 22, such as a keyboard or the like. Optionally, the GUI 20 and the input/output device 22 are combined and comprise a touch-screen display or the like. The processor 16 then directs the data storage media recording device 12 to record the selected digital content on the recordable data storage medium 14. The potential digital content may be stored in the memory 18 of the digital content kiosk 10 or, alternatively, may be retrieved from a remote location via a network interface 24. The network interface 24 includes a telephone modem, a cable modem, a DSL line, a T1 line, a local-area network (LAN), a wide-area network (WAN), a global network, such as the Internet, and/or the like. The potential digital content may be stored in one or more local or remote hard drives or file, database or web servers.

Preferably, the recordable data storage medium 14 has sufficient data storage capacity to record the desired digital content. For example, for the storage of movies, typically including 2 to 3 hours of video encoded using the MPEG-2 format, the required data storage capacity is between about 4 GB and about 9 GB, preferably between about 4 GB and about 5 GB. Optionally, the digital content is re-encoded or otherwise compressed using any number of techniques well known to those of ordinary skill in the art. Preferably, the data transfer time required to record the digital content on the recordable data storage medium 14 is less than about 45 minutes, more preferably less than about 30 minutes, and most preferably less than about 15 minutes.

Preferably, the digital content kiosk 10 also includes a payment receiving device 26 and/or a payment processing device 28, well known to those of ordinary skill in the art. The payment receiving device 26 and/or the payment processing device 28 are operable for receiving cash from the user and/or processing the user's magnetically-encoded credit card, debit card and/or the like. Alternatively, the processor 16 is configured to run an authorization/identification subroutine, such that an authorized user may be identified (via a password or otherwise) and allowed to download and record digital content. The digital content kiosk 10 further includes a recordable data storage medium delivery device 30 operable for delivering the recordable data storage medium 14 to the user once the selected digital content has been recorded on it.

Optionally, the data storage medium delivery device 30 coats or prints a reactive layer onto the recordable data storage medium 14, rendering the recordable data storage medium 14 limited-play, before delivering the recordable data storage medium 14 to the user. Preferably, the digital content kiosk 10 contains a supply of recordable data storage media 14 stored in packages and/or in an inert environment. Once digital content is recorded on a given recordable data storage medium 14, the recordable data storage medium delivery device 30 may repackage the recordable data storage medium 14 prior to delivery to the user or, alternatively, without repackaging. In an overlapping embodiment, the data storage medium delivery device 30 repackages the recordable data storage medium 14 in a package with at least one oxygen scavenger. The oxygen scavenger may be, for example, but not by way of limitation, a film. In another overlapping embodiment, the data storage medium delivery device 30 evacuates the gases and/or flushes, with an inert gas, the package for the recordable data storage medium 14 before sealing the package. In one exemplary embodiment, the package is hermetically sealed. In the case that the recordable data storage medium 14 is repackaged, the user has a predetermined amount of time from the time that the recordable data storage medium 14 is removed from the packaging until the digital content expires. In the case that the recordable data storage medium 14 is not repackaged, the user has a predetermined amount of time from the time that the recordable data storage medium 14 is delivered to the user by the recordable data storage medium delivery device 30 until the digital content expires.

Alternatively, the digital content may expire after a predetermined amount of time as determined from the time that the recordable data storage medium 14 is first accessed and/or played by the end user.

Optionally, the digital content kiosk 10 contains pre-recorded data storage media for the low-quantity distribution of digital content.

Optionally, the digital content kiosk 10 includes structures well known to those of ordinary skill in the art that are capable of printing, either directly or indirectly, on the recordable data storage medium 14 and/or applying a label onto a non-reading side of the recordable data storage medium 14. The printing and/or applying of a label on the recordable data storage medium 14 allows for the medium to be identified as to the content and/or title of the data stored thereon.

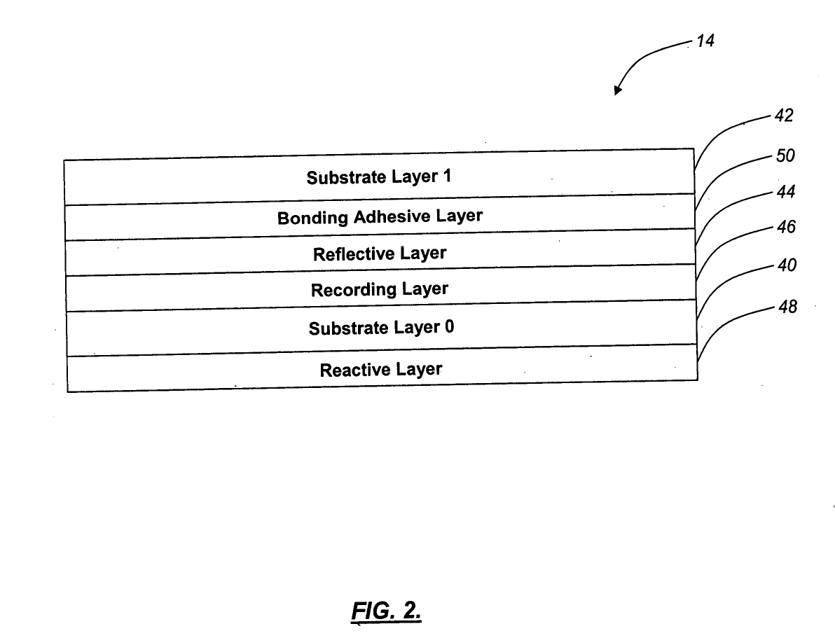

Referring to FIGS. 2-6, in various embodiments, the limited-play recordable data storage medium 14 of the present invention includes a plurality of layers. These layers include, but are not limited to, a first substrate layer 40 (substrate layer 0) comprising a thermoplastic, such as a polycarbonate or the like; a second substrate layer 42 (substrate layer 1) also comprising a thermoplastic, such as a polycarbonate or the like; a reflective layer 44 comprising a metal, such as Al, Ag or Au, or the like; a recording layer 46 (also referred to herein as a “data layer”) comprising a recordable material, such as phthalocyanine or the like, or a re-writable material, such as an MO material, a phase-change material, a chalcogenide or the like; a reactive layer 48 comprising a reactive material, such as leuco methylene blue, or the like; a bonding adhesive layer 50; and/or a reactive bonding adhesive layer 52. Each of the layers is described in greater detail herein below.

It should be noted that, although preferred layer combinations are illustrated and described herein, other layer combinations will be readily apparent to those of ordinary skill in the art and are contemplated by the present invention. It should also be noted that digital content may be recorded on the limited-play recordable data storage medium 14 of the present invention before or after the deposition of a reactive layer 48 and/or a reactive bonding adhesive layer 52. For example, if a reactive layer 48 is deposited on the surface of the limited-play recordable data storage medium 14, it may be deposited before or after the digital content is recorded. If a reactive layer 48 and/or a reactive bonding adhesive layer 52 are deposited between the first substrate layer 40 and the second substrate layer 42, they are most likely deposited before the digital content is recorded.

Referring to FIG. 2, in one embodiment, the limited-play recordable data storage medium 14 of the present invention includes the following layers, in order: a reactive layer 48 comprising a reactive material, such as leuco methylene blue, or the like; a first substrate layer 40 (substrate layer 0) comprising a polycarbonate or the like; a recording layer 46 comprising a recordable material, such as phthalocyanine, or the like; a reflective layer 44 comprising a metal, such as Al, Ag or Au, or the like; a bonding adhesive layer 50; and a second substrate layer 42 (substrate layer 1) also comprising a polycarbonate or the like.

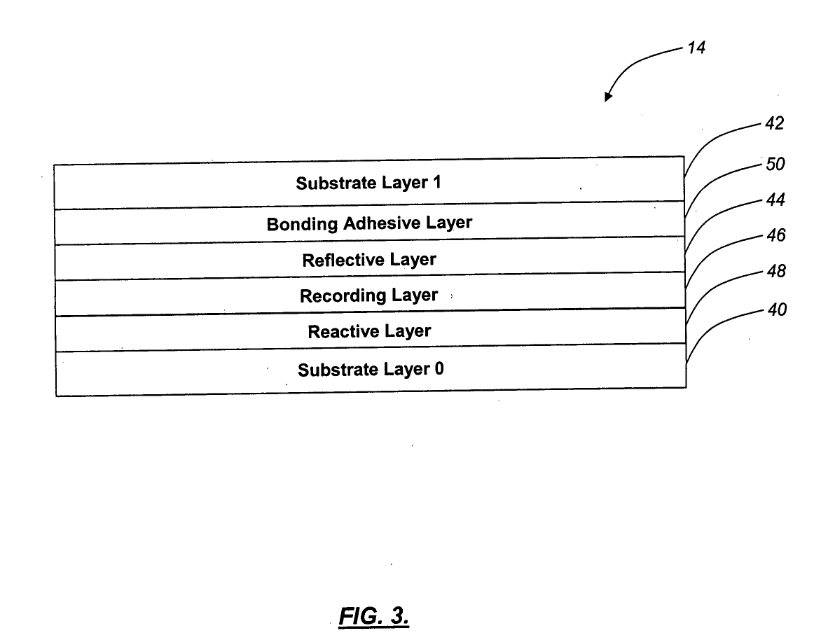

Referring to FIG. 3, in another embodiment, the limited-play recordable data storage medium 14 of the present invention includes the following layers, in order: a first substrate layer 40 (substrate layer 0) comprising a polycarbonate or the like; a reactive layer 48 comprising a reactive material, such as leuco methylene blue, or the like; a recording layer 46 comprising a recordable material, such as phthalocyanine, or the like; a reflective layer 44 comprising a metal, such as Al, Ag or Au, or the like; a bonding adhesive layer 50; and a second substrate layer 42 (substrate layer 1) also comprising a polycarbonate or the like.

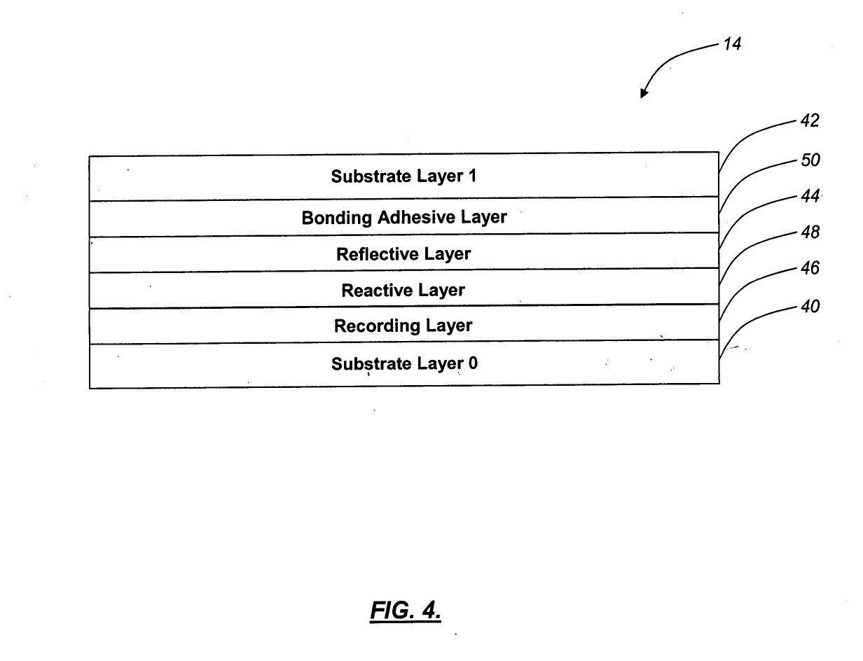

Referring to FIG. 4, in a further embodiment, the limited-play recordable data storage medium 14 of the present invention includes the following layers, in order: a first substrate layer 40 (substrate layer 0) comprising a polycarbonate or the like; a recording layer 46 comprising a recordable material, such as phthalocyanine, or the like; a reactive layer 48 comprising a reactive material, such as leuco methylene blue, or the like; a reflective layer 44 comprising a metal, such as Al, Ag or Au, or the like; a bonding adhesive layer 50; and a second substrate layer 42 (substrate layer 1) also comprising a polycarbonate or the like.

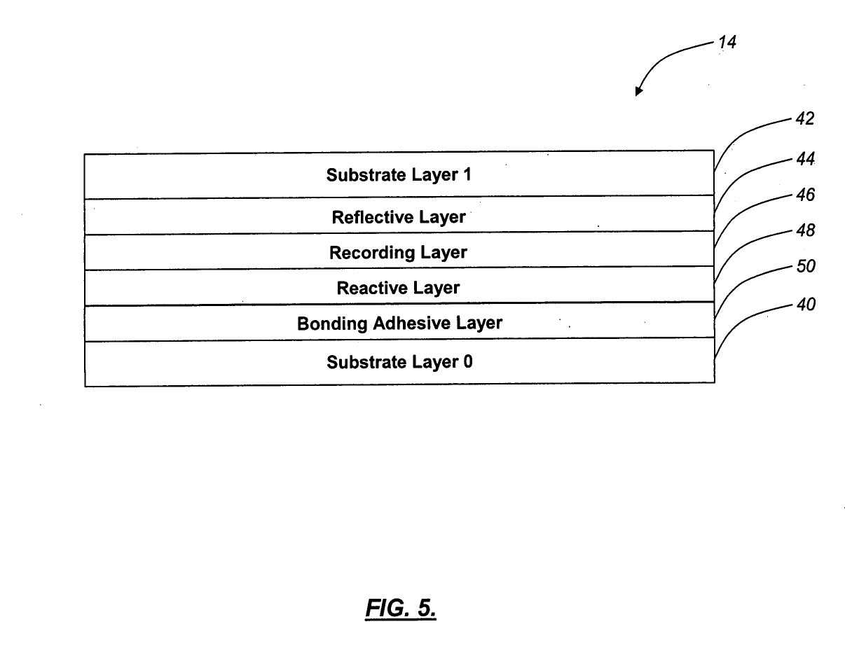

Referring to FIG. 5, in a still further embodiment, the limited-play recordable data storage medium 14 of the present invention includes the following layers, in order: a first substrate layer 40 (substrate layer 0) comprising a polycarbonate or the like; a bonding adhesive layer 50; a reactive layer 48 comprising a reactive material, such as leuco methylene blue, or the like; a recording layer 46 comprising a recordable material, such as phthalocyanine, or the like; a reflective layer 44 comprising a metal, such as Al, Ag or Au, or the like; and a second substrate layer 42 (substrate layer 1) also comprising a polycarbonate or the like.

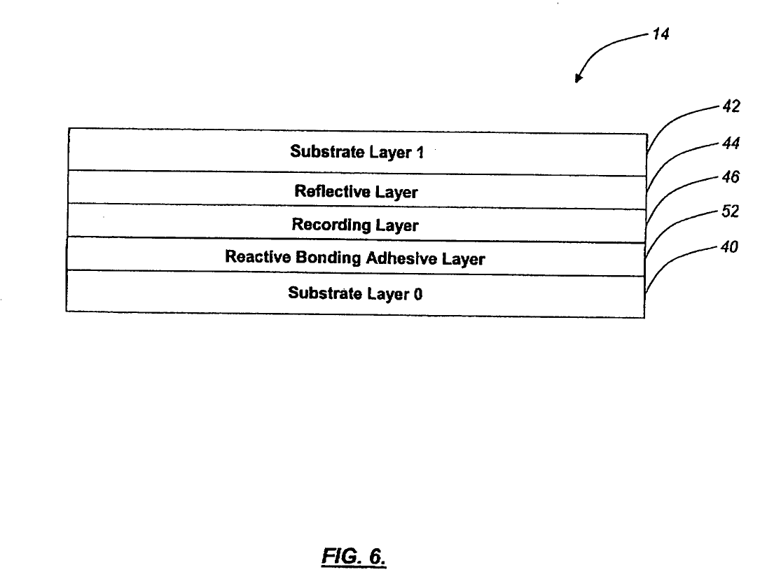

Referring to FIG. 6, in a still further embodiment, the limited-play recordable data storage medium 14 of the present invention includes the following layers, in order: a first substrate layer 40 (substrate layer 0) comprising a polycarbonate or the like; a reactive bonding adhesive layer 52; a recording layer 46 comprising a recordable material, such as phthalocyanine, or the like; a reflective layer 44 comprising a metal, such as Al, Ag or Au, or the like; and a second substrate layer 42 (substrate layer 1) also comprising a polycarbonate or the like.

In general, the digital content kiosk of the present invention utilizes a limited-play recordable data storage medium, such as a limited-play recordable optical, magnetic or magneto-optic data storage medium. The data storage medium includes one or more reactive layers and/or one or more reactive bonding adhesive layers that each contain a reactive dye, such as an essentially colorless leuco dye (e.g., methylene blue), and one or more additives. Preferably, the one or more additives include resorcinol or a derivative of resorcinol and, optionally, polyhydroxystyrene (PHS). Advantageously, it has been discovered that the photo-bleaching of data storage media containing methylene blue, resorcinol or a derivative of resorcinol and PHS in the reactive layer(s) and/or the reactive bonding adhesive layer(s) is significantly retarded as compared to the photo-bleaching of conventional data storage media.

Preferably, the data storage medium includes one or more substrates having low birefringence and high light transmittance at a read laser wavelength. In other words, the data storage medium is readable in an optical media device or the like and recordable in an optical media recording device or the like. Typically, the read laser wavelength is in the range of between about 390 nm and about 430 nm (incorporating a blue or blue-violet laser), or in the range of between about 630 nm and about 650 nm (incorporating a red laser). The data storage medium may also include a light-absorbing layer. The one or more substrates are made of a material having sufficient optical clarity to render the data layer readable in the optical media device and recordable in the optical media recording device, i.e. the one or more substrates have a birefringence of about ±100 nm or less. In theory, any plastic that exhibits these properties may be employed as a substrate. However, the plastic must be capable of withstanding the required processing parameters, such as the application of subsequent layers via sputtering or the like at temperatures of between about 25 degrees C. (room temperature) and about 150 degrees C. The plastic must also be capable of withstanding typical storage conditions, such as storage in a hot car at temperatures up to about 70 degrees C. In other words, it is desirable for the plastic to have sufficient thermal stability to prevent deformation during the various layer deposition steps, as well as during storage by the user. Suitable plastics include thermoplastics with glass transition temperatures of about 100 degrees C. or more, preferably about 125 degrees C. or more, more preferably about 150 degrees C. or more, most preferably about 200 degrees C. or more. Examples include polyetherimides, polyetheretherketones, polysulfones, polyethersulfones, polyetherethersulfones, polyphenylene ethers, polyimides and polycarbonates. Plastics with glass transition temperatures of about 250 degrees C. or more include polyetherimides in which sulfonedianiline or oxydianiline has been substituted for m-phenylenediamine, as well as polyimides and combinations of the above-referenced plastics. Typically, polycarbonates are employed.

Suitable substrate materials include, but are not limited to, amorphous, crystalline and semi-crystalline thermoplastics, such as: polyvinyl chloride, polyolefins (including, but not limited to, linear and cyclic polyolefins, polyethylene, chlorinated polyethylene and polypropylene), polyesters (including, but not limited to, polyethylene terephthalate, polybutylene terephthalate and polycyclohexylmethylene terephthalate), polyamides, polysulfones (including, but not limited to, hydrogenated polysulfones), polyimides, polyether imides, polyether sulfones, polyphenylene sulfides, polyether ketones, polyether ether ketones, ABS resins, polystyrenes (including, but not limited to, hydrogenated polystyrenes, syndiotactic and atactic polystyrenes, polycyclohexyl ethylene, styrene-co-acrylonitrile and styrene-co-maleic anhydride), polybutadiene, polyacrylates (including, but not limited to, polymethylmethacrylate (PMMA) and methyl methacrylate-polyimide copolymers), polyacrylonitrile, polyacetals, polycarbonates, polyphenylene ethers (including, but not limited to, those derived from 2,6-dimethylphenol and copolymers with 2,3,6-trimethylphenol), ethylene-vinyl acetate copolymers, polyvinyl acetate, liquid crystal polymers, ethylene-tetrafluoroethyiene copolymers, aromatic polyesters, polyvinyl fluoride, polyvinylidene fluoride, polyvinylidene chloride and tetrafluoroethylenes (e.g., Teflons).

As used herein, the terms “polycarbonate” and “polycarbonate composition” include compositions having structural units of the formula (I): 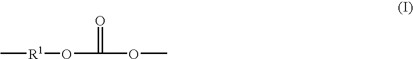
in which at least about 60 percent of the total number of R¹ groups are aromatic organic radicals and the balance thereof are aliphatic, alicyclic or aromatic radicals. Preferably, R¹ is an aromatic organic radical and, more preferably, a radical of the formula (II):
—A¹—Y¹—A²— (II)
wherein each of A¹ and A² is a monocyclic divalent aryl radical and Y¹ is a bridging radical having zero, one or two atoms which separate A¹ from A². In an exemplary embodiment, one atom separates A¹ from A². Illustrative, non-limiting examples of radicals of this type are —O—, —S—, —S(O)—, —S(O₂)—, —C(O)—, methylene, cyclohexylmethylene, 2-[2,2,1]-bicycloheptylidene, ethylidene, isopropylidene, neopentylidene, cyclohexylidene, cyclopentadecylidene, cyclododecylidene and adamantylidene. In another exemplary embodiment, zero atoms separate A¹ from A², with an illustrative example being biphenol. The bridging radical Y¹ can be a hydrocarbon group or a saturated hydrocarbon group, for example, methylene, cyclohexylidene, isopropylidene or a herteroatom, such as —O— or —S—.

Polycarbonates can be produced by the reaction of dihydroxy compounds in which only one atom separates A¹ from A². As used herein, the term “dihydroxy compound” includes, for example, a bisphenol compound having the general formula (III): 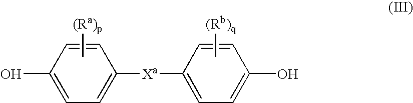
wherein R^{a} and R^{b} each independently represent hydrogen, a halogen atom or a monovalent hydrocarbon group; p and q are each independently integers from 0 to 4; and X^{a} represents one of the groups of formula (IV): 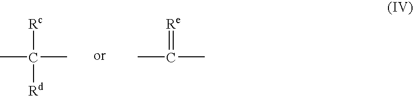
wherein R^{c} and R^{d} each independently represent a hydrogen atom or a monovalent linear or cyclic hydrocarbon group and Re is a divalent hydrocarbon group.

Some illustrative, non-limiting examples of suitable dihydroxy compounds include dihydric phenols and the dihydroxy-substituted aromatic hydrocarbons, such as those disclosed by name or formula (generic or specific) in U.S. Pat. No. 4,217,438. A non-exclusive list of specific examples of the types of bisphenol compounds that may be represented by formula (III) includes the following: 1,1-bis(4-hydroxyphenyl) methane; 1,1-bis(4-hydroxyphenyl) ethane; 2,2-bis(4-hydroxyphenyl) propane (hereinafter “bisphenol A” or “BPA”); 2,2-bis(4-hydroxyphenyl) butane; 2,2-bis(4-hydroxyphenyl) octane; 1,1-bis(4-hydroxyphenyl) propane; 1,1-bis(4-hydroxyphenyl) n-butane; bis(4-hydroxyphenyl) phenylmethane; 2,2-bis(4-hydroxy-3-methylphenyl) propane (hereinafter “DMBPA”); 1,1-bis(4-hydroxy-t-butylphenyl) propane; bis(hydroxyaryl) alkanes, such as 2,2-bis(4-hydroxy-3-bromophenyl) propane; 1,1-bis(4-hydroxyphenyl) cyclopentane; 9,9′-bis(4-hydroxyphenyl) fluorene; 9,9′-bis(4-hydroxy-3-methylphenyl) fluorene; 4,4′-biphenol; bis(hydroxyaryl) cycloalkanes, such as 1,1-bis(4-hydroxyphenyl) cyclohexane and 1,1-bis(4-hydroxy-3-methylphenyl) cyclohexane (hereinafter “DMBPC” or “BCC”); and the like, as well as combinations including at least one of the above-referenced bisphenol compounds.

It is also possible to employ polycarbonates resulting from the polymerization of two or more different dihydric phenols or a copolymer of a dihydric phenol with a glycol or with a hydroxy or acid-terminated polyester or with a dibasic acid or with a hydroxy acid or with an aliphatic diacid in the event that a carbonate copolymer, rather than a homopolymer, is desired for use. Generally, useful aliphatic diacids have carbon atoms in the range of between about 2 and about 40. A preferred aliphatic diacid is dodecandioic acid.

Polyarylates and polyester-carbonate resins or their blends may also be employed. Branched polycarbonates are also useful, as well as blends of linear polycarbonates and branched polycarbonates. The branched polycarbonates may be prepared by adding a branching agent during polymerization.

Branching agents are well known to those of ordinary skill in the art and may include polyfunctional organic compounds containing at least three functional groups which may be hydroxyl, carboxyl, carboxylic anhydride, haloformyl and mixtures comprising at least one of the foregoing branching agents. Specific examples include, but are not limited to, trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)α,α-dimethyl benzyl)phenol), 4-chloroformyl phthalic anhydride, trimesic acid, and benzophenone tetracarboxylic acid, as well as combinations including at least one of the foregoing branching agents. The branching agents may be added at a level in the range of between about 0.05 and about 2 weight percent, based upon the total weight of the substrate. Examples of branching agents and procedures for making branched polycarbonates are described in U.S. Pat. Nos. 3,635,895 and 4,001,184. All types of polycarbonate end groups are contemplated herein.

Preferred polycarbonates are based on bisphenol A, in which each of A¹ and A² is p-phenylene and Y¹ is isopropylidene. Preferably, the average molecular weight of the polycarbonate is between about 5,000 and about 100,000 atomic mass units, more preferably between about 10,000 and about 65,000 atomic mass units, most preferably between about 15,000 and about 35,000 atomic mass units.

The polycarbonate composition may also include various additives ordinarily incorporated in resin compositions of this type. Such additives include, for example, fillers or reinforcing agents, heat stabilizers, antioxidants, light stabilizers, plasticizers, antistatic agents, mold releasing agents, additional resins and blowing agents, as well as combinations including at least one of the foregoing additives.

In order to aid in the processing of the substrate material (e.g., the production of a polycarbonate via a melt process) or to control a property of the substrate material (e.g., viscosity), one or more catalysts may also be employed. Exemplary catalysts include, but are not limited to, tetraalkylammonium hydroxide and tetraalkylphosphonium hydroxide, with diethyldimethylammonium hydroxide and tetrabutylphosphonium hydroxide preferred. The one or more catalysts may be employed alone or in combination with quenchers, such as acids (e.g., phosphorous acid) and the like. Additionally, water may be injected into the polymer melt during compounding and removed as water vapor through a vent to remove residual volatile compounds.

Data storage media can be produced by first forming the substrate material using a conventional reaction vessel capable of adequately mixing various precursors, such as a single or twin-screw extruder, kneader, blender or the like. The extruder should be maintained at a sufficiently high temperature to melt the substrate material precursors without causing the decomposition thereof. For polycarbonates, for example, temperatures in the range of between about 220 degrees C. and about 360 degrees C. can be used, preferably in the range of about 260 degrees C. and about 320 degrees C. Similarly, the residence time in the extruder should be controlled to minimize decomposition. Residence times of up to about 2 minutes or more can be employed, with residence times of up to about 1.5 minutes preferred and residence times of up to about 1 minute especially preferred. Prior to extrusion into the desired form (typically pellets, a sheet, a web or the like), the mixture can optionally be filtered, such as by melt filtering, the use of a screen pack or combinations thereof, to remove undesirable contaminants and/or decomposition products.

Once the plastic composition has been produced, it can be formed into the substrate using various molding and/or processing techniques. Exemplary molding and/or processing techniques include, but are not limited to, injection molding, film casting, extrusion, press molding, blow molding and stamping. Once the substrate has been produced, additional processing, such as electroplating, coating (via spin coating techniques, spray coating techniques, vapor deposition techniques, screen printing techniques, painting techniques, dipping techniques and the like), lamination, sputtering and/or the like, may be employed to dispose desired layers on the substrate. Typically, the substrate has a thickness of up to about 600 microns.

An example of a limited-play recordable polycarbonate data storage medium includes one or more injection molded polycarbonate substrates. Other various layers that may be disposed on the one or more substrates include: one or more recording or data layers, one or more reflective layers, one or more dielectric layers, one or more reactive layers, one or more bonding adhesive layers, one or more reactive bonding adhesive layers, one or more protective layers and one or more light-absorbing layers, as well as combinations including at least one of the foregoing layers. It is to be understood that the form of the data storage medium is not limited to a disc shape, but may be of any shape and size that may be accommodated in a readout and/or recording device.

With respect to the limited-play recordable data storage medium, data is encoded by a laser that illuminates an active data layer that undergoes a phase change, thus producing a series of highly-reflective and/or non-reflective regions making up a data stream. In such formats, a laser beam first travels through one of the substrates before reaching the data layer. At the data layer, the beam is either reflected or not, in accordance with the encoded data. The laser beam then travels back through one of the substrates and into an optical detector system where the data is interpreted. Thus, the data layer is disposed between one of the substrates and the reflective layer. The data layer for an optical application typically comprises pits and/or grooves on one of the substrates. Preferably, the data layer is embedded in the surface of one of the substrates. Typically, an injection molding-compression technique is used to produce the substrate, wherein a mold is filled with a molten polymer. The mold may contain a preform, insert, etc. The polymer is cooled and, while still in at least a partially molten state, compressed to imprint the desired surface features, such as pits and/or grooves, arranged in a spiral concentric or other suitable orientation onto the desired portions of the substrate (e.g., one or both sides of the substrate).

Exemplary data layers for magnetic or magneto-optic applications include any material that is capable of storing retrievable data, such as: oxides (including, but not limited to, silicone oxide), rare earth elements and transition metal alloys, such as nickel, cobalt, chromium, tantalum, platinum, terbium, gadolinium, iron, boron and combinations and alloys including at least one of the foregoing, organic dyes (e.g., cyanine and phthalocyanine-type dyes) and inorganic phase change compounds (e.g., TeSeSn and InAgSb).

The one or more protective layers that protect against dust, oils and other contaminants can have a thickness of greater than about 100 microns to less than about 10 Å, with a thickness of about 300 Å or less preferred in some embodiments and a thickness of about 100 Å or less especially preferred in some embodiments. The thickness of the one or more protective layers is usually determined, at least in part, by the type of read/write mechanism employed (e.g., optical, magnetic or magneto-optic). Exemplary protective layers include, but are not limited to, anticorrosive materials, such as gold, silver, nitrides (e.g., silicon nitride and aluminum nitride), carbides (e.g., silicon carbide), oxides (e.g., silicon dioxide), polymeric materials (e.g., polyacrylates and polycarbonates), carbon film (e.g., diamond and diamond-like carbon) and combinations including at least one of the foregoing.

The one or more dielectric layers, which may be disposed on one or both sides of the data layer and are often employed as heat controllers, typically have a thickness of as high as about 1,000 Å or more and as low as about 200 Å or less. Exemplary dielectric layers include, but are not limited to, nitrides (e.g., silicon nitride and aluminum nitride), oxides (e.g., aluminum oxide), sulfides (e.g., zinc sulfide), carbides (e.g., silicon carbide) and combinations including at least one of the foregoing, among other materials compatible within the environment of and preferably not reactive with the surrounding layers.

The one or more reflective layers should have sufficient thickness to reflect a sufficient amount of energy (e.g., light) to enable data retrieval. Typically, the one or more reflective layers have a thickness of up to about 700 Å, with a thickness in the range of about 300 Å to about 600 Å preferred. Exemplary reflective layers include any material capable of reflecting the particular energy field, including metals (e.g., aluminum, gold, silver, silicon, titanium and alloys and combinations including at least one of the foregoing).

The one or more reactive layers and/or the one or more reactive bonding adhesive layers each include a reactive material. The reactive material initially provides sufficient transmission to enable data retrieval by the data storage media device and subsequently forms one or more layers that inhibit data retrieval by the data storage media device. In other words, the reactive material absorbs a predetermined amount of incident light, reflected light or a combination thereof at the wavelength of the light source associated with the data storage media device. Typically, a layer that allows an initial percent reflectivity from the reflective layer of about 50% or greater can be employed, with an initial percent reflectivity of about 65% or greater preferred and an initial percent reflectivity of about 75% or greater more preferred. Once the given data storage medium has been exposed to oxygen (e.g., air) for a desired period of time (e.g., the desired allowable play time of the data storage medium), the layer preferably allows a subsequent percent reflectivity from the reflective layer of about 45% or less, with a subsequent percent reflectivity of about 30% or less more preferred, a subsequent percent reflectivity of about 20% or less even more preferred and a subsequent percent reflectivity of about 10% or less most preferred.

Exemplary reactive materials include, but are not limited to, oxygen sensitive leuco methylene blue or reduced forms of methylene blue, brilliant cresyl blue, basic blue 3 and toluidine 0, as well as reaction products and combinations including at least one of the foregoing, the structures of which are set forth below:

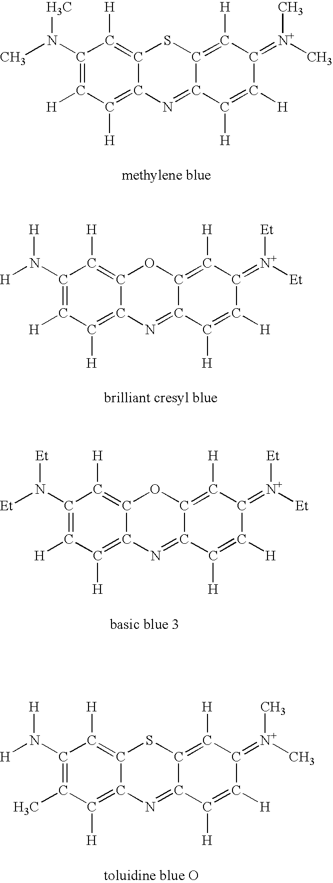

Another possible reactive material includes a dye that reoxidizes over approximately 48 hours without an ultraviolet (UV) coating.

The method of synthesis and the oxygen dependent reoxidation to create the colored form of the methylene blue is shown below:

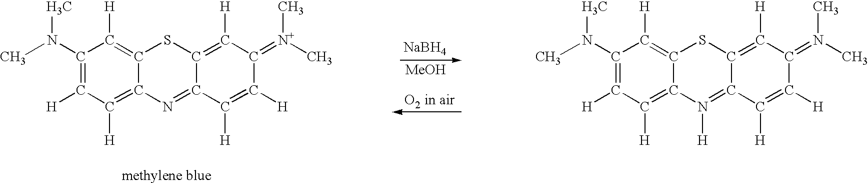

Additionally, the one or more reactive layers and/or the one or more reactive bonding adhesive layers contain at least one photo-bleaching retarder, such as a polyhydroxy compound. Suitable polyhydroxy compounds include, but are not limited to, biphenols and biphenol derivatives, bisphenols and bisphenol derivatives, other diols, di and tri-hydroxybenzene derivatives and combinations thereof. The photo-bleaching retarder can be a small molecule or polymer, such as ployhydroxystyrene (poly-4-vinyl phenol). The polyhydroxy compound effectively reduces photo-bleaching. Typically, the critical reflectivity is less than about 20%. More typically, the critical reflectivity is less than about 10%.

Suitable polydihydroxy compounds include those represented by the formula (V): 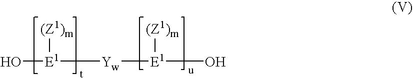
wherein Y represents a non-conjugated bridging group (e.g., alkylene, oxygen, sulfur, —OCH₂CH₂O— and the like) and w represents an integer between zero and three; E¹ represents an aromatic group (e.g., phenylene, biphenylene and naphthylene); Z¹ may be an inorganic atom including, but not limited to, halogen (fluorine, bromine, chlorine, iodine), an inorganic group including, but not limited to, nitro, an organic group including, but not limited to, a monovalent hydrocarbon group, such as alkyl, aryl, aralkyl, alkaryl, or cycloalkyl, or an oxy group, such as OR² (wherein R² is a hydrogen or a monovalent hydrocarbon group, such as alkyl, aryl, aralkyl, alkaryl, or cycloalkyl); m represents an integer between and including zero and the number of positions on E¹ that are available for substitution; t represents an integer equal to at least one; and u represents zero or an integer equal to at least one, with the proviso that if u is zero, m represents an integer between and including two through the number of positions on E¹ that are available for substitution. In some particular embodiments, Z¹ includes a halo group or a C₁-C₆ alkyl group. When more than one Z¹ substituent is present, as represented by Formula (VI), they may be the same or different. The positions of the hydroxyl groups and Z¹ on the aromatic residues E¹ can be varied in the ortho, meta or para positions and the groupings can be in a vicinal, asymmetrical or symmetrical relationship, where two or more ring carbon atoms of the aromatic residue are substituted with Z¹ and hydroxyl groups.

Exemplary polyhydroxy compounds include those represented by the formula (VI): 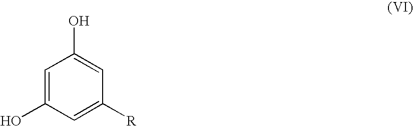
wherein R may be an inorganic atom including, but not limited to halogen (fluorine, bromine, chlorine, iodine); an inorganic group including, but not limited to, nitro; an organic group including, but not limited to, a monovalent hydrocarbon group, such as alkyl, aryl, aralkyl, alkaryl, or cycloalkyl, or an oxy group, such as OR² (wherein R² is a hydrogen or a monovalent hydrocarbon group, such as alkyl, aryl, aralkyl, alkaryl, or cycloalkyl).

Exemplary polyhydroxy compounds include, but are not limited to, resorcinol, 2,4-biresorcinol, me4biphenol, 4-phenylphenol, bisphenol A, 1,1,1-tris(p-hrdroxyphenyl) ethane (hereinafter “THPE”); 4-hexylresorcinol, 4,4′-biphenol, 3,3′-biphenol, 2,2′-biphenol, 2,2′,6,6′-tetramethyl-3,3′,5,5′-tetrabromo-4,4′-biphenol, 2,2′,6,6′-tetramethyl-3,3′,5-tribromo-4,4′-biphenol, 3,3′-dimethylbiphenyl-4,4′-diol, 3,3′-ditert-butylbiphenyl-4,4′-diol, 3,3′,5,5′-tetramethylbiphenyl-4,4′-diol, 2,2′-ditert-butyl-5,5′-dimethylbiphenyl4,4′-diol, 3,3′-ditert-butyl-5,5′-dimethylbiphenyl4,4′-diol, 3,3′,5,5′-tetratert-butylbiphenyl-4,4′-diol, 2,2′,3,3′,5,5′-hexamethylbiphenyl4,4′-diol, 2,2′,3,3′,5,5′,6,6′-octamethylbiphenyl4,4′-diol, 3,3′-di-n-hexylbiphenyl4,4′-diol, 3,3′-di-n-hexyl-5,5′-dimethylbiphenyl-4,4′-diol, 2-methylresorcinol, 5-methylresorcinol, 5-heptylresorcinol, resorcinol monoacetate, resorcinol monobenzoate, 2,4-dihydroxybenzophenone, 2,4,2′,4′-tetrahydroxybenzophenone, 2,4-dihydroxybenzoic acid, 4-hexylresorcinol, 2,4-dihydroxybenzoic acid, 2,5-dihydroxybenzoic acid, 3,5-dihydroxybenzoic acid, 1,2,4-trihydroxybenzene, and the like. Typically, the polyhydroxy compound is present in a range of between about 1 weight % and about 20 weight %, more typically in a range of between about 3 weight percent (%) and about 15 weight %, and most typically in a range of between about 5 weight % and about 10 weight %, based upon the total weight of the reactive layer or reactive adhesive layer.

Other suitable polyhydroxy compounds include:
Cardol (a mixture of alk(en)ylresorcinols; present in Cashew Nut Shell Liquid): 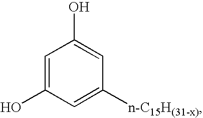
2-methylcardol,
esters of 2,4-dihydroxybenzoic acid (e.g., benzyl ester),
esters of 3,5-dihydroxybenzoic acid such as: 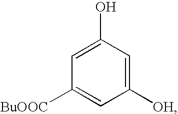
alkylene-bis-(dihydric phenol) ethers such as: 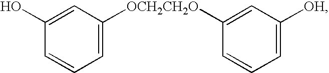
diamides of m-aminophenol such as: 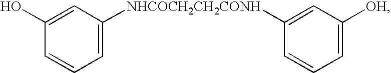
p-xylylene-bis-2,4-dihydroxybenzoate: 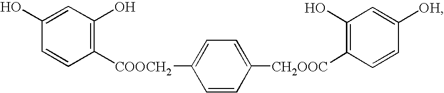
1,3-bis(4′-hydroxyphenoxy)benzene: 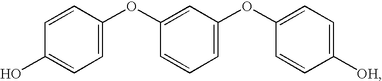
2,4-dihydroxybenzophenone,
2,4,2′,4′-tetrahydroxybenzophenone,
2-hydroxy-4-(2-hydroxyethoxy)benzophenone,
2,2′-dihydroxy-4-methoxybenzophenone,
2,2′-dihydroxy4,4′-dimethoxybenzophenone,
2-hydroxy-4-methoxybenzophenone-5-sulfonic acid,
phenyl 1-hydroxynapthoate (monohydroxy),
polyhydroxystyrene,
2-(2-hydroxy-p-anisoyl)benzoic acid,
2,4-dihydroxybenzoic acid,
2,5-dihydroxybenzoic acid,
3,5-dihydroxybenzoic acid,
1-hydroxy-2-napthoic acid (monohydroxy), and
polyvinylphenol.

In addition to the above-referenced reactive materials, numerous other dyes and light blocking materials can be synthesized and operate to render the data storage media limited play. For example, other possible reactive materials can be found in U.S. Pat. Nos. 4,404,257 and 5,815,484. The reactive material can also be a mixture including at least one of the above-referenced reactive materials.

The amount of reactive material in the reactive layer and/or the reactive bonding adhesive layer is dependent upon the desired life of the data storage medium. For example, the amount of reactive material in the reactive layer can be as little as about 0.1 weight percent, with about 1 weight percent preferred, based upon the total weight of the reactive layer, with an upper amount of reactive material being about 10 weight percent, with about 7 weight percent preferred, about 6 weight percent more preferred, and about 5 weight percent most preferred.

In the case of the one or more reactive layers, the reactive material is preferably mixed with a carrier or polymer binder for deposition on, impregnation into or a combination of deposition on and impregnation into at least a portion of the surface of the substrate. The carrier is typically present in the range of between about 65% and about 85%, and more typically in the range of between about 70% and about 80%, based upon the total weight of the reactive layer. Exemplary carriers include thermoplastic acrylic polymers, polyester resins, epoxy resins, polythiolenes, UV curable organic resins, polyurethanes, thermosettable acrylic polymers, alkyds, vinyl resins and the like, as well as combinations including at least one of the foregoing. Polyesters include, for example, the reaction products of aliphatic dicarboxylic acids, including, for example, fumaric or maleic acid with glycols, such as ethylene glycol, propylene glycol, neopentyl glycol and the like, as well as reaction products and mixtures including at least one of the foregoing.

Exemplary epoxy resins that can be the used as the carrier include, but are not limited to, monomeric, dimeric, oligomeric and polymeric epoxy materials containing one or a plurality of epoxy functional groups. Examples include the reaction products of bisphenol-A and epichlorohydrin, epichlorohydrin with phenolformaldehyde resins and the like. Other organic resins can be in the form of mixtures of polyolefin and polythiols, such as those provided in U.S. Pat. Nos. 3,697,395 and 3,697,402.

The term “thermoplastic acrylic polymers”, as used herein, is meant to embrace within its scope those thermoplastic polymers resulting from the polymerization of one or more acrylic acid ester monomers, as well as methacrylic acid ester monomers. These monomers are represented by the general formula (VII):
CH₂═CWCOOR^{f} (VII)
wherein W is hydrogen or a methyl radical and R^{f} is an alkyl radical, preferably an alkyl radical including carbon atoms in the range of between about 1 and about 20. Some non-limiting examples of alkyl groups represented by R^{f} include: methyl, ethyl, n-propyl, isopropyl, n-butyl, isobutyl, sec-butyl, tert-butyl, pentyl, isopentyl, hexyl and the like.

Some non-limiting examples of acrylic acid ester monomers represented by Formula (VII) include: methyl acrylate, isopropyl acrylate, n-propyl acrylate, n-butyl acrylate, isobutyl acrylate, 2-ethylhexyl acrylate and the like. Some non-limiting examples of methacrylic acid ester monomers represented by Formula (VII) include: methyl methacrylate, ethyl methacrylate, butyl methacrylate, hexyl methacrylate, isobutyl methacrylate, propyl methacrylate and the like, as well as reaction products and combinations including at least one of the foregoing.

Copolymers of the above-referenced acrylate and methacrylate monomers are also included within the term “thermoplastic acrylic polymers”, as it appears herein. Preferably, the thermoplastic acrylic polymer is a copolymer of poly(methyl methacrylate/methacrylic acid). The polymerization of the monomeric acrylic acid esters and methacrylic acid esters to provide the thermoplastic acrylic polymers may be accomplished by any polymerization technique well known to those of ordinary skill in the art. The thermoplastic acrylic polymers typically have an inherent viscosity of less than about 0.300 centimeters cubed per gram (cm³g⁻¹), more typically of less than about 0.250 cm³g⁻¹, and most typically of less than about 0.200 cm³g⁻¹.

In order to enhance adhesion of the reactive layer to the substrate, in the event that a reactive layer is utilized, a primer may be employed therebetween. The thermoplastic acrylic polymers useful as primers include: acrylic homopolymers derived from a single type of acrylic acid ester monomer; methacrylic homopolymers derived from a single type of methacrylic acid ester monomer; copolymers derived from two or more different acrylic acid ester monomers, two or more different methacrylic acid ester monomers or an acrylic acid ester monomer and a methacrylic acid ester monomer; and the like, as well as combinations including at least one of the foregoing.

Mixtures of two or more of the above-referenced thermoplastic acrylic polymers, e.g., two or more different acrylic homopolymers, two or more different acrylic copolymers, two or more different methacrylic homopolymers, two or more different methacrylic copolymers, an acrylic homopolymer and a methacrylic homopolymer, an acrylic copolymer and a methacrylic copolymer, an acrylic homopolymer and a methacrylic copolymer, an acrylic copolymer and a methacrylic homopolymer and reaction products thereof, can also be used.

Optionally, the reactive layer can be applied to the substrate using various coating techniques such as painting, dipping, flow-coating, spraying, spin coating, inkjet printing, pad printing, screen printing and the like. For example, the reactive layer can be mixed with a relatively volatile solvent, preferably an organic solvent, which is substantially inert towards the polycarbonate, i.e., will not attack and adversely affect the polycarbonate, but which is capable of dissolving the carrier. Generally, the concentration of the carrier in the solvent is about 0.5 weight % or greater, with about 10 weight % or greater preferred, while the upper range of the polymer is about 25 weight %, with about 20 weight % or less preferred. With some coating techniques, such as inkjet printing, the lower range of the polymer is about 0.5 weight % to about 5 weight %, with about 1 weight % or more preferred. Examples of some suitable organic solvents include ethylene glycol diacetate, butoxyethanol, methoxypropanol, the lower alkanols and the like. Generally, the concentration of the solvent in the coating solution is about 70 weight % or greater, with about 75 weight % or greater preferred, while the upper range of the solvent is about 95 weight %, with about 85 weight % or less preferred.

The reactive layer may also optionally contain various additives, such as flatting agents, surface active agents, thixotropic agents and the like, and reaction products and combinations including at least one of the foregoing.

The thickness of the reactive layer is dependent upon the particular reactive material employed, the concentration thereof in the reactive layer and the desired absorption characteristics of the reactive layer, both initially and after a desired period of time. When the reactive material is applied in a coating formulation, the reactive layer can have a thickness as low as about 1 micron (μ), with about 2μ preferred, and about 3μ more preferred. On the upper end, the thickness can be up to about 15μ or greater, with up to about 10μ preferred, and up to about 6μ more preferred. When the reactive material is applied in the adhesive, the reactive layer can be between 30 and 80 microns, and more preferably between 40 and 60 microns.

Typically, the reactive layer and/or the reactive bonding adhesive layer is disposed between the reflective layer and one of the substrates. The reactive layer and reflective layer may be in a sandwich configuration between the first substrate and a second substrate. The reactive layer in a sandwich configuration has a first percentage reflectivity that exceeds a second percentage reflectivity, wherein the second percentage reflectivity is a percentage reflectivity for the reactive layer had it not been in a sandwich configuration.

Typically, the molded substrate is deaerated before the reactive layer is disposed on the substrate. Additionally, the reactants used to make the reactive layer are typically kept in an inert environment. After the data storage medium has been produced, the disc is typically kept in an inert environment until the disc is ready for use. Typically, deaeration can occur with any inert gas, for example, nitrogen, argon or helium.

The substrate may also include a colorant additive such that the substrate is a light-absorbing layer to filter the light reaching the reactive layer. Photo-bleaching resistance may be improved by limiting the wavelengths of light that can be transmitted through the substrate into the reactive layer. The light-absorbing layer typically transmits less than about 90% of light in at least one wavelength a range between about 390 nm and about 630 nm. In a further embodiment of the present invention, the light-absorbing layer typically transmits less than about 10% of light in at least one wavelength in a range between about 455 nm and about 620 nm, and more typically, transmits less than about 10% of light in a range between about 475 nm and about 620 nm. Most typically, the light-absorbing layer transmits less than about 1% of light in at least one wavelength in a range between about 550 nm and about 620 nm. In a further embodiment of the present invention, the light-absorbing layer typically transmits less than about 60% of light in at least one wavelength in a range between about 390 nm and about 435 nm, more typically transmits less than about 40% of light in at least one wavelength in a range between about 390 nm and about 435 nm, and most typically less than about 10% of light in at least one wavelength in a range between about 390 nm and about 435 nm. The light-absorbing layer is disposed between the reactive layer and the laser beam. Typically the light-absorbing layer has a thickness of up to about 600 microns.

Typically, a colorant or combination of colorants is present in the light-absorbing layer. The colorant is typically present in a range between about 0.00001 weight % and about 2 weight %, more typically, in a range between about 0.001 weight % and about 1 weight %, and most typically, in a range between about 0.01 weight % and about 0.5 weight %, based on the total weight of the light-absorbing layer. Colorants are also preferably selected so that they solubilize in the material used to form the layer in which the colorant is disposed. Colorants that are soluble in the materials used for DVD layers include dyes (e.g., “solvent dyes”), organic colorants, pigments, and the like, which behave like dyes; i.e., colorants that disperse in the plastic and do not form aggregates having a size greater than or equal to about 200 nm, with an aggregate size less than or equal to about 50 nm preferred. Some suitable colorants include, but are not limited to, those of the chemical family of anthraquinones, perylenes, perinones, indanthrones, quinacridones, xanthenes, oxazines, oxazolines, thioxanthenes, indigoids, thioindigoids, naphtalimides, cyanines, xanthenes, methines, lactones, coumarins, bis-benzoxaxolylthiophenes (BBOT), napthalenetetracarboxylic derivatives, monoazo and disazo pigments, triarylmethanes, aminoketones, bis(styryl)biphenyl derivatives, and the like, as well as combinations including at least one of the foregoing colorants.

The following is a partial list of commercially available, suitable dyes:
Color Index Solvent Red 52
Color Index Solvent Red 207
Color Index Disperse Orange 47
Color Index Solvent Orange 60
Color Index Disperse Yellow 54
Color Index Disperse Yellow 201
Color Index Pigment Yellow 138
Color Index Solvent Violet 36
Color Index Solvent Violet 13
Color Index Disperse Violet 26
Color Index Solvent Blue 97
Color Index Solvent Blue 59
Color Index Solvent Green 3
Color Index Solvent Green 28
Color Index Solvent Red 135
Color Index Solvent Red 179
1,5-dihydroxy-4,8-bis(phenylamino)-9,10-anthracenedione

The bonding adhesive layer can adhere any combination of the above-referenced layers. In a preferred embodiment of the present invention, the bonding adhesive layer comprises a reactive bonding adhesive layer (described in further detail herein below). Optionally, the reactive bonding adhesive layer comprises the sole reactive layer associated with the data storage medium. The bonding adhesive layer can include any material that is capable of forming a layer penetrable by oxygen and that, unless otherwise so desired, does not substantially interfere with the transfer of light through the data storage medium from and to the data retrieval device (e.g., that is substantially transparent at the wavelength of light utilized by the data retrieval device, and/or which allows a reflectivity from the data storage medium of about 50% or greater, with a percent reflectivity of about 65% or greater preferred and a percent reflectivity of about 75% or greater more preferred). Exemplary bonding adhesive materials include, but are not limited to, UV materials, such as acrylates (e.g., cross-linked acrylates and the like), silicon hardcoats and the like, as well as reaction products and combinations including at least one of the foregoing. Other examples of UV materials are described in U.S. Pat. Nos. 4,179,548 and 4,491,508. Some useful polyfunctional acrylate monomers include, for example, diacrylates of the formulas:

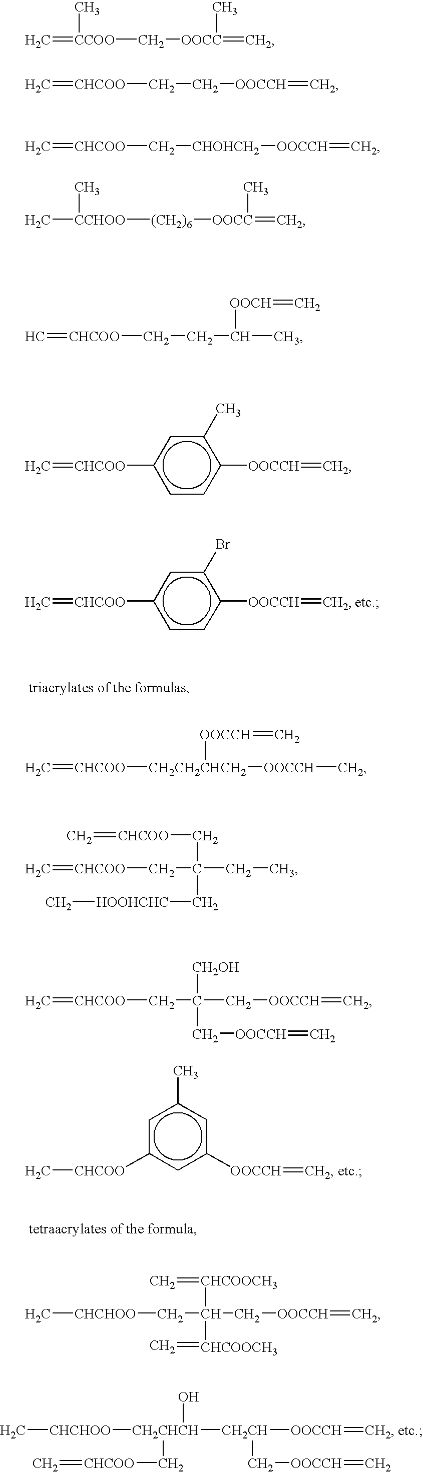

Although the bonding adhesive layer may contain only one of said polyfunctional acrylate monomers, or a mixture including at least one of the polyfunctional acrylate monomers (and the UV light reaction product thereof), preferred coating compositions contain a mixture of two polyfunctional monomers (and the UV light reaction product thereof), preferably a diacrylate and a triacrylate (and the UV light reaction product thereof), with minor amounts of mono-acrylate used in particular instances. Optionally, the bonding adhesive layer can comprise nonacrylic UV curable aliphatically unsaturated organic monomers in amounts up to about 50 weight % of the uncured adhesive coating that includes, for example, such materials as N-vinyl pyrrolidone, styrene and the like, and reaction products and combinations including at least one of the foregoing materials.

Optionally, the bonding adhesive layer may comprise a mixture of acrylate monomers. Exemplary mixtures of diacrylates and triacrylates include mixtures of hexanediol diacrylate with pentaerythritol triacrylate, hexanediol diacrylate with trimethylolpropane triacrylate, diethylene glycol diacrylate with pentaerythritol triacrylate, and diethylene glycol diacrylate with trimethylolpropane triacrylate and the like.

The bonding adhesive layer can also comprise a photosensitizing amount of photoinitiator, i.e., an amount effective to affect the photocure of the bonding adhesive layer. Generally, this amount includes about 0.01 weight %, with about 0.1 weight % preferred, up to about 10 weight %, with about 5 weight % preferred, based upon the total weight of the adhesive layer. Exemplary photoinitiators include, but are not limited to, blends of ketone-type and hindered amine-type materials that form suitable hard coatings upon exposure to UV radiation. It is preferable that the ratio, by weight, of the ketone compound to the hindered amine compound be about 80/20 to about 20/80. Ordinarily, about 50/50 or about 60/40 mixtures are quite satisfactory.

Other possible ketone-type photoinitiators, which preferably are used in a nonoxidizing atmosphere, such as nitrogen, include: benzophenone and other acetophenones, benzil, benzaldehyde and 0-chlorobenzaldehyde, xanthone, thioxanthone, 2-clorothioxanthone, 9,10-phenanthrenenquinone, 9,10-anthraquinone, methylbenzoin ether, ethylbenzoin ether, isopropyl benzoin ether, α,α-diethoxyacetophenone, α,α-dimethoxyacetophenone, 1-phenyl-1,2-propanediol-2-o-benzoyl oxime, α,α-dimethoxy-α-phenylacetopheone, phosphine oxides and the like. Further included are reaction products and combinations including at least one of the foregoing photoinitiators.

The photocure of the bonding adhesive layer may also be affected by the light-absorbing layer. When a light-absorbing layer is used that transmits more than about 5% of light in at least one wavelength in a range between about 330 nanometers and about 390 nanometers, or more preferably, transmits more than about 10% of light in at least one wavelength in a range between about 360 nanometers and about 370 nanometers, the bonding adhesive layer has an improved bonding capability. When the bonding adhesive layer has an “improved bonding capability”, the time it takes the storage medium for data to reach 45% reflectivity exceeds the time is takes a storage medium for data to reach 45% reflectivity with a light-absorbing layer that absorbs light that falls outside the above-referenced range.

Optionally, the bonding adhesive layer may also include flatting agents, surface active agents, thixotropic agents, UV light stabilizers, UV absorbers and/or stabilizers such as resorcinol monobenzoate, 2-methyl resorcinol dibenzoate and the like, as well as combinations and reaction products including at least one of the foregoing. The stabilizers can be present in an amount, based upon the weight of the uncured UV layer of about 0.1 weight %, preferably about 3 weight %, to about 15 weight %.

As described above, limited-play recordable data storage media are made by incorporating an essentially colorless leuco dye in a reactive layer (comprising poly (methyl methacrylate) (PMMA) or the like) or, alternatively, in a UV-curable acrylate reactive bonding adhesive layer used to bond the various layers of the data storage media. Upon exposure to oxygen, the leuco dye is oxidized to form a highly colored layer that serves to make the data storage media unplayable in a data storage media device. It has been found that limited-play data storage media made using leuco methylene blue/methylene blue as the dye are relatively easily defeated via photo-bleaching by sunlight or other intense visible light such that the data storage media are no longer limited play. Photo-bleaching may be significantly retarded through the addition of a photo-bleaching retarder, such as a polyhydroxy compound. Suitable polyhydroxy compounds include, but are not limited to, biphenols and biphenol derivatives, bisphenols and bisphenol derivatives, resorcinol or a resorcinol derivative, other diols, di and tri-hydroxybenzene derivatives and combinations of the foregoing. The photo-bleaching retarder can be a small molecule or polymer, such as polyhydroxystyrene (poly-4-vinyl phenol). Through the addition of resorcinol or the like to a dye-containing reactive layer or reactive bonding adhesive layer, the color stability of an expired data storage medium may be improved from about 20 hrs in a weatherometer (about 1 week of sunlight exposure) to about 200 hrs in the weatherometer (about 10 weeks of sunlight exposure). Advantageously, the resorcinol-containing reactive layers and/or bonding adhesive layers also demonstrate synergies with red substrate materials.

In general, poor solubility in an adhesive is observed with small molecule polyhydroxy compounds, such as biphenol, propyl gallate and the like. However, resorcinol demonstrates good solubility in the adhesive when PHS is present as a compatibilizer. For example, a formulation containing no PHS and about 10 wt % resorcinol provides a cloudy adhesive and the resulting data storage medium contains particulates. A formulation containing about 7 wt % PHS and about 5 wt % resorcinol provides a slightly cloudy adhesive, but the resulting data storage medium appears to be acceptable. A formulation containing about 12 wt % PHS and about 2-4 wt % resorcinol provides a relatively clear adhesive and the resulting data storage medium is acceptable. It is also desirable that the adhesive formulation remains stable during storage. After about 1 week of storage in a refrigerator, a formulation containing about 12 wt % PHS and about 5 wt % resorcinol was found to contain precipitated crystals of resorcinol. Alternatives to resorcinol with improved solubility and long term stability in the adhesive may be used. For example, formulations containing 4-hexylresorcinol or chlororesorcinol provide relatively clear adhesives that remain stable after several weeks in a refrigerator. Table 1 summarizes the photo-bleaching performances for a number of exemplary reactive adhesive formulations using a colorless substrate.

TABLE 1
Photo-Bleaching Performance of Exemplary
Reactive Adhesive Formulations (Colorless Substrate)

| Colorless | | | | | | | | | |
|---|---|---|---|---|---|---|---|---|---|
| substrate | | | | | | | | | |
| Ex- | | Time in weather-o-meter (hrs) | | | | | | | |
| am- | | 0 | 20 | 40 | 60 | 80 | 176 | 196 | 216 |
| ple | Additive | | % Ref after exposure time | | | | | | |
| 1 | 12% PHS | 4.8 | 24.2 | 37.3 | 44.0 | 46.0 | 51.9 | 52.1 | 53.0 |
| 2 | 7% PHS, | 4.8 | 18.1 | 26.6 | 31.1 | 36.6 | 38.3 | 36.5 | 37.2 |
| | 5% RS | | | | | | | | |
| 3 | 0% PHS, | 4.9 | 18.6 | 27.8 | 31.9 | 37.3 | 41.5 | 40.4 | 41.8 |
| | 5% RS | | | | | | | | |

TABLE 2
Photo-Bleaching Performance of Exemplary
Reactive Adhesive Formulations (Red Substrate)
Table 2 summarizes the photo-bleaching performances for a number
of exemplary reactive adhesive formulations using a red substrate.

| Red substrate | | Time in weather-o-meter (hrs) | | | | | | | |
|---|---|---|---|---|---|---|---|---|---|
| Exam- | | 0 | 20 | 40 | 60 | 80 | 176 | 196 | 216 |
| ple | Additive | % Ref after exposure time | | | | | | | |
| 4 | 12% PHS | 4.8 | 4.7 | 5.0 | 6.3 | 9.9 | 29.1 | 32.5 | 34.1 |
| 5 | 7% PHS, 5% RS | 4.8 | 4.8 | 4.9 | 5.0 | 5.0 | 5.5 | 5.5 | 5.5 |
| 6 | 0% PHS, 5% RS | 4.9 | 5.7 | 6.3 | 6.1 | 7.9 | 8.1 | 7.1 | 7.2 |

In order that those of ordinary skill in the art will be better able to practice the present invention, the following examples are given by way of illustration, and not by way of limitation:

### EXAMPLE 1

A solution of PMMA in 1-methoxy-2-propanol was prepared by adding 60 grams of Elvacite 2010 poly (methyl methacrylate) from Ineos Acrylics to 300 grams of 1-methoxy-2-propanol in a bottle and rolling the bottle on a roller mill to effect dissolution. The solution was transferred to a flask and heated to about 80 degrees C. while a slow stream of nitrogen was passed over the surface of the solution. The de-aerated solution was transferred using nitrogen pressure to a de-aerated bottle closed with a rubber septum using a cannula tube.

A leuco methylene blue solution was prepared by combining 1.2 grams of methylene blue trihydrate and 0.8 grams of camphor sulfonic acid with 40 grams of 1-methoxy-2-propanol in a 100-mL flask equipped with a rubber septum. The stirred mixture was heated in a 90 degrees C. water bath while a stream of nitrogen was passed into the flask using syringe needles for both the nitrogen inlet and for an outlet. While hot, 4.2 mL of Tin (II) 2-ethylhexanoate was added by syringe to reduce the methylene blue to the dark amber leuco methylene blue. To the solution was added 0.6 mL of flow additive BYK-301 from BYK Chemie. To make the PMMA/leuco methylene blue coating solution, the leuco methylene blue solution above was drawn into a syringe and then injected into the PMMA solution after having been passed through a 0.2-micron syringe filter.

### EXAMPLE 2

A solution was prepared as in Example 1, except that the following quantitites of raw materials were used:

| | wt (g) |
|---|---|
| PMMA Solution | |
| Dowanol PM [g] | 67.1 |
| Total Elvacite [g] | 15.2 |
| Elvacite 2008 | 15.2 |
| Elvacite 2010 | 0.0 |
| Dye Solution | |
| methylene blue trihydrate [g] | 0.66 |
| camphorsulfonic acid [g] | 0.28 |
| Dowanol PM [g] | 14.87 |
| stannous octanoate [g] | 2.85 |
| Fluorad 50% solids FC-431 [ml] | 0.15 |

The solution was used to apply a PMMA/leuco methylene blue basecoat to a 0.6 mm metalized BPA-polycarbonate DVD first substrate using a spin coater at 800 rpm for 60 seconds. The average coating thickness was found to be about 3 microns. After one of the discs with the PMMA/leuco methylene blue basecoat had been stored overnight in a nitrogen chamber, UV resin Daicure SD-640 was dispensed in a thin ring to the middle of the previously-coated metalized DVD first substrate. Then, an unmetalized BPA-polycarbonate second substrate was placed on top the first substrate disc with the ring of UV resin. The sandwich was spun at 1000 rpm for 10 seconds to disperse the UV adhesive evenly. The sandwich was then passed under a flash Xenon UV lamp for 25 seconds. The sandwich was stored in a nitrogen chamber for at least 48 hours prior to packaging in an oxygen-impermeable mylar-foil bag.

### EXAMPLE 3

A limited-play DVD was prepared as in Example 2 above. However, the PMMA/leuco methylene blue solution was applied to the data (laser-incident) surface of a bonded, 1.2 mm-thick DVD instead of the 0.6 mm metalized BPA-polycarbonate DVD first substrate. As above, the coating was applied using a spin-coater with a spin-speed of 800 rpm for 60 sec. The coated disc was then stored in a nitrogen chamber for at least 48 hours prior to packaging in an oxygen-impermeable mylar-foil bag.

### EXAMPLE 4

A limited-play recordable DVD-R disc was prepared using a similar method as described in Example 3 above. A PMMA/leuco methylene blue solution was applied to the data (laser-incident) surface of a DVD-R disc. As above, the coating was applied using a spin-coater with a spin-speed of 800 rpm for 60 sec. The coated DVD-R disc was then placed in a Pioneer DVR-105 DVD-R drive and a digital video was recorded to the disc. The recording process was completed in about 30 minutes. After completion of the recording process, the disc was placed in a Sony DVP-S360 DVD player to verify that the video was playable. Three days later the disc was not playable when it was re-inserted into the DVD player.

### EXAMPLE 5

A limited-play recordable DVD-R disc was prepared using a similar method as described in Example 4 above. After the digital video was recorded, the disc was packaged in an oxygen impermeable mylar-foil bag. One week later the disc was removed from the bag and placed in the DVD player to verify that it was playable. Two to three days later the disc was not playable when it was re-inserted into the DVD player.

### EXAMPLE 6

A limited-play recordable DVD-R disc was prepared using a similar method as described in Example 3 above, except that the reactive coating was applied after the DVD-R disk was recorded. A DVD-R disc was placed in a Pioneer DVR-105 DVD-R drive and a digital video was recorded to the disc. After completion of the recording process, a PMMA/leuco methylene blue solution was applied to the data (laser-incident) surface of a DVD-R disc. As above, the coating was applied using a spin-coater with a spin-speed of 800 rpm for 60 sec. The coated disc was then placed in a Sony DVP-S360 DVD player to verify that the video was playable. Three days later the disc was not playable when it was re-inserted into the DVD player.

Although the present invention has been illustrated and described with reference to preferred embodiments and examples thereof, it will be readily apparent to those of ordinary skill in the art that other embodiments and examples may perform similar functions and/or achieve similar results. All such equivalent embodiments and examples are within the spirit and scope of the present invention and are intended to be covered by the following claims.

1. A digital content kiosk system operable for delivering selected digital content to a user, the digital content kiosk system comprising:
a recordable data storage medium configured to receive selected digital content, wherein the recordable data storage medium comprises a limited-play recordable data storage medium, the limited-play recordable data storage medium expiring after a predetermined amount of time; and
a data storage media recording device operable for recording the selected digital content on the recordable data storage medium at the request of a user.

2. The digital content kiosk system of claim 1, further comprising a processor operable for directing and controlling the operation of the data storage media recording device.

3. The digital content kiosk system of claim 1, further comprising a memory operable for storing the selected digital content.

4. The digital content kiosk system of claim 3, wherein the memory is disposed within the digital content kiosk system.

5. The digital content kiosk system of claim 3, wherein the memory is disposed at a remote location from the digital content kiosk system.

6. The digital content kiosk system of claim 1, further comprising a network interface operable for accessing the selected digital content.

7. The digital content kiosk system of claim 6, wherein the network interface comprises at least one of a telephone modem, a cable modem, a DSL line, a T1 line, a local-area network (LAN), a wide-area network (WAN), and a global network (the Internet).

8. The digital content kiosk system of claim 1, further comprising a graphical user interface (GUI) operable for allowing the user to select the selected digital content from a group of potential digital content.

9. The digital content kiosk system of claim 1, further comprising an input/output device operable for allowing the user to select the selected digital content from a group of potential digital content.

10. The digital content kiosk system of claim 1, further comprising a payment receiving device operable for receiving a payment from the user.

11. The digital content kiosk system of claim 1, further comprising a payment processing device operable for processing a payment from the user.

12. The digital content kiosk system of claim 1, further comprising a recordable data storage medium delivery device operable for delivering the recordable data storage medium containing the selected digital content to the user.

13. The digital content kiosk system of claim 12, wherein the recordable data storage medium delivery device is further operable for applying a reactive coating to a surface of the recordable data storage medium prior to delivering the recordable data storage medium containing the selected digital content to the user, the reactive coating rendering the recordable data storage medium limited-play.

14. The digital content kiosk system of claim 12, wherein the recordable data storage medium delivery device is further operable for packaging the recordable data storage medium prior to delivering the recordable data storage medium containing the selected digital content to the user, the packaging providing an inert environment for the recordable data storage medium.

15. The digital content kiosk system of claim 1, wherein the recordable data storage medium comprises a recordable data storage medium selected from the group consisting of a CD-R, a CD-RW, a DVD-R, a DVD-RW, a DVD+RW, a DVD-RAM, an MO disc, a non-volatile memory card, and a removable magnetic hard drive cartridge.

16. The digital content kiosk system of claim 1, wherein the limited-play recordable data storage medium is stored in an inert environment within the digital content kiosk system.

17. The digital content kiosk system of claim 1, wherein the limited-play recordable data storage medium comprises at least one of a reactive layer and a reactive bonding adhesive layer.

18. The digital content kiosk system of claim 17, wherein the at least one of the reactive layer and the reactive bonding adhesive layer comprises a reactive material.

19. The digital content kiosk system of claim 18, wherein the reactive material comprises at least one of oxygen-sensitive leuco methylene blue, a reduced form of methylene blue, a reduced form of brilliant cresyl blue, a reduced form of basic blue 3, and a reduced form of toluidine 0.

20. The digital content kiosk system of claim 17, wherein the at least one of the reactive layer and the reactive bonding adhesive layer comprises at least one photo-bleaching retarder.

21. The digital content kiosk system of claim 20, wherein the at least one photo-bleaching retarder comprises at least one of a polyhydroxy compound and polyhydroxystyrene.

22. The digital content kiosk system of claim 21, wherein the polyhydroxy compound comprises at least one of resorcinol, 4-hexylresorcinol, chlororesorcinol, and 2,4-dihydrobenzoic acid.

23. The digital content kiosk system of claim 1, wherein the data storage media recording device comprises a data storage media recording device selected from the group consisting of a CD-R device, a CD-RW device, a DVD-R device, a DVD-RW device, a DVD+RW device, a DVD-RAM device, an MO disc device, a non-volatile memory card device, and a removable magnetic hard drive cartridge device.

24. The digital content kiosk system of claim 1, wherein the selected digital content comprises digital content selected from the group consisting of a digital photograph, music, a movie preview, a movie, a video game, computer software, and computer data.

25. A method for delivering selected digital content to a user, the method comprising:
providing a recordable data storage medium configured to receive selected digital content, wherein the recordable data storage medium comprises a limited-play recordable data storage medium, the limited-play recordable data storage medium expiring after a predetermined amount of time;
providing a data storage media recording device operable for recording the selected digital content on the recordable data storage medium; and
recording the selected digital content on the recordable data storage medium at the request of a user.

26. The method of claim 25, further comprising providing a processor operable for directing and controlling the operation of the data storage media recording device.

27. The method of claim 25, further comprising providing a memory operable for storing the selected digital content.

28. The method of claim 27, wherein providing the memory comprises disposing the memory in close proximity to the data storage media recording device.

29. The method of claim 27, wherein providing the memory comprises disposing the memory at a remote location from the data storage media recording device.

30. The method of claim 25, further comprising providing a network interface operable for accessing the selected digital content.

31. The method of claim 30, wherein the network interface comprises at least one of a telephone modem, a cable modem, a DSL line, a T1 line, a local-area network (LAN), a wide-area network (WAN), and a global network (the Internet).

32. The method of claim 25, further comprising providing a graphical user interface (GUI) operable for allowing the user to select the selected digital content from a group of potential digital content.

33. The method of claim 25, further comprising providing an input/output device operable for allowing the user to select the selected digital content from a group of potential digital content.

34. The method of claim 25, further comprising providing a payment receiving device operable for receiving a payment from the user.

35. The method of claim 25, further comprising providing a payment processing device operable for processing a payment from the user.

36. The method of claim 25, further comprising providing a recordable data storage medium delivery device operable for delivering the recordable data storage medium containing the selected digital content to the user.

37. The method of claim 36, wherein the recordable data storage medium delivery device is further operable for applying a reactive coating to a surface of the recordable data storage medium prior to delivering the recordable data storage medium containing the selected digital content to the user, the reactive coating rendering the recordable data storage medium limited-play.

38. The method of claim 36, wherein the recordable data storage medium delivery device is further operable for packaging the recordable data storage medium prior to delivering the recordable data storage medium containing the selected digital content to the user, the packaging providing an inert environment for the recordable data storage medium.

39. The method of claim 25, wherein the recordable data storage medium comprises a recordable data storage medium selected from the group consisting of a CD-R, a CD-RW, a DVD-R, a DVD-RW, a DVD+RW, a DVD-RAM, an MO disc, a non-volatile memory card, and a removable magnetic hard drive cartridge.

40. The method of claim 25, further comprising storing the limited-play recordable data storage medium in an inert environment.

41. The method of claim 25, wherein the limited-play recordable data storage medium comprises at least one of a reactive layer and a reactive bonding adhesive layer.

42. The method of claim 41, wherein the at least one of the reactive layer and the reactive bonding adhesive layer comprises a reactive material.

43. The method of claim 42, wherein the reactive material comprises at least one of oxygen-sensitive leuco methylene blue, a reduced form of methylene blue, a reduced form of brilliant cresyl blue, a reduced form of basic blue 3, and a reduced form of toluidine 0.

44. The method of claim 41, wherein the at least one of the reactive layer and the reactive bonding adhesive layer comprises at least one photo-bleaching retarder.

45. The method of claim 44, wherein the at least one photo-bleaching retarder comprises at least one of a polyhydroxy compound and polyhydroxystyrene.

46. The method of claim 45, wherein the polyhydroxy compound comprises at least one of resorcinol, 4-hexylresorcinol, chlororesorcinol, and 2,4-dihydrobenzoic acid.

47. The method of claim 25, wherein the data storage media recording device comprises a data storage media recording device selected from the group consisting of a CD-R device, a CD-RW device, a DVD-R device, a DVD-RW device, a DVD+RW device, a DVD-RAM device, an MO disc device, a non-volatile memory card device, and a removable magnetic hard drive cartridge device.

48. The method of claim 25, wherein the selected digital content comprises digital content selected from the group consisting of a digital photograph, music, a movie preview, a movie, a video game, computer software, and computer data.
